(19) United States
(12) Patent Application Publication
(10) Pub. No.: US 2014/0068208 A1
(43) Pub. Date: Mar. 6, 2014

(54) SEPARATELY STORED REDUNDANCY

(71) Applicant: Timothy Richard Feldman, Louisville, CO (US)

(72) Inventor: Timothy Richard Feldman, Louisville, CO (US)

(73) Assignee: SEAGATE TECHNOLOGY LLC, Cupertino, CA (US)

(21) Appl. No.: 13/596,262

(22) Filed: Aug. 28, 2012

(51) Int. Cl. G06F 12/16

(52) U.S. Cl. 711/162; 711/E12.103

(57) ABSTRACT

A method or system stores a data block redundancy related to a data block of a storage medium together with the mapping metadata for the data block. In an alternative implementation, redundancy storage location is on a separate block of the storage medium, the separate block being in a storage region other than the storage region of the data block.

### SUMMARY

A method or system stores a data block redundancy related to a data block of a storage medium together with the mapping metadata for the data block.

These and various other features and advantages will be apparent from a reading of the following detailed description.

### BRIEF DESCRIPTIONS OF THE DRAWINGS

A further understanding of the various implementations described herein may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates a block diagram of an implementation of a system for separately stored redundancy.

FIG. 2 illustrates a block diagram of an alternate implementation of a system for separately stored redundancy.

FIG. 3 illustrates a block diagram of an alternate implementation of a system for separately stored redundancy.

FIG. 4 illustrates an example data structure of a redundancy stored separately from data.

FIG. 5 illustrates example operations for providing separately stored redundancy in a data storage system.

FIG. 6 illustrates example operations for providing separately stored redundancy in a data storage system.

### DETAILED DESCRIPTIONS

In the following description, for the purposes of explanation, numerous specific details are set forth in order to provide a thorough understanding of the various implementations described herein. While various features are ascribed to particular implementations, it should be appreciated that the features described with respect to one implementation may be incorporated with other implementations as well. By the same token, however, no single feature or features of any described implementation should be considered essential, as other implementations may omit such features.

It is desirable that storage devices have very low rates of unrecoverable data and low rates of returning wrong data. In other words, storage devices are generally designed to provide very high data integrity and/or authenticity. To achieve such high rates of authenticity, often storage devices use redundancy for data reliability and data authentication. For example, data block redundancy is often generated generating a longitudinal parity check from a specified block of data on a track, etc. Other methods for creating data block redundancy include vertical redundancy check, etc.

Sources of wrong data in storage devices include mis-correction by the error detection and correction codes, hard and soft errors in hardware, hardware bugs, firmware bugs, etc. Bugs are particularly insidious in that the errors generated by them are generally not repeatable and therefore it is difficult to discover the root causes that generate the failures. Furthermore, some authenticity and/or redundancy checks are themselves set up by hardware or firmware that use information that has been corrupted by the bug as inputs. Such double-fault conditions can cause the checks not to catch the failures that they were intended to detect.

In one implementation, a storage device adds redundancy to the stored data for error detection and correction. This is primarily for tolerating the data faults that come with imperfect storage media. For example, the redundancy is added to the same location where the data is stored. Alternately, the redundancy is calculated based on the data, attached to the data, and the combination of the data and related redundancy are stored at a location on the storage device. In one implementation, the calculation of the redundancy also includes the address of the media where the data is stored. This allows verification that data is fetched from the correct address when the data is read.

In an alternate implementation, a storage device uses dynamic mapping to provide direction between a host-specified address and a media address selected by the drive. For example, such dynamic mapping is used by a solid-state drive (SSD), a shingled magnetic recording (SMR) drive, etc. Such drives have a forward map that specifies the media address for a given host logical address. The maps are typically managed in one or two sizes of mapping. In one implementation, the ranges are fine-grained mapping as small as a single host block and the coarse-grained mapping as big as an erasure block or SMR band. Write operations that update the data associated with a host-specified address use forward map access for one of two reasons: either the existing mapping needs to be determined for a write-in-place update, or the mapping needs to be updated to reflect the new media location. In the latter case, the previous mapping is typically needed to update information about what locations have become stale.

In an implementation disclosed herein, data redundancy is also used for providing a higher level of data authentication. The technology disclosed herein provides storing redundancy information about data blocks of storage media at a location different from the location of the data block. For example, the redundancy information may be stored with the mapping metadata of the storage device, such as mapping metadata of a dynamically mapped storage device. For example, when instruction for a write operation is received from a host device, the storage device generates redundancy for the data to be written. Yet alternatively, the mapping metadata includes a forward map entry that points to the media location for the data storage. In such an implementation, the storing and retrieving the redundancy is managed with the same process as used for the storing and retrieving of the forward map entries that points to the media location for the data storage.

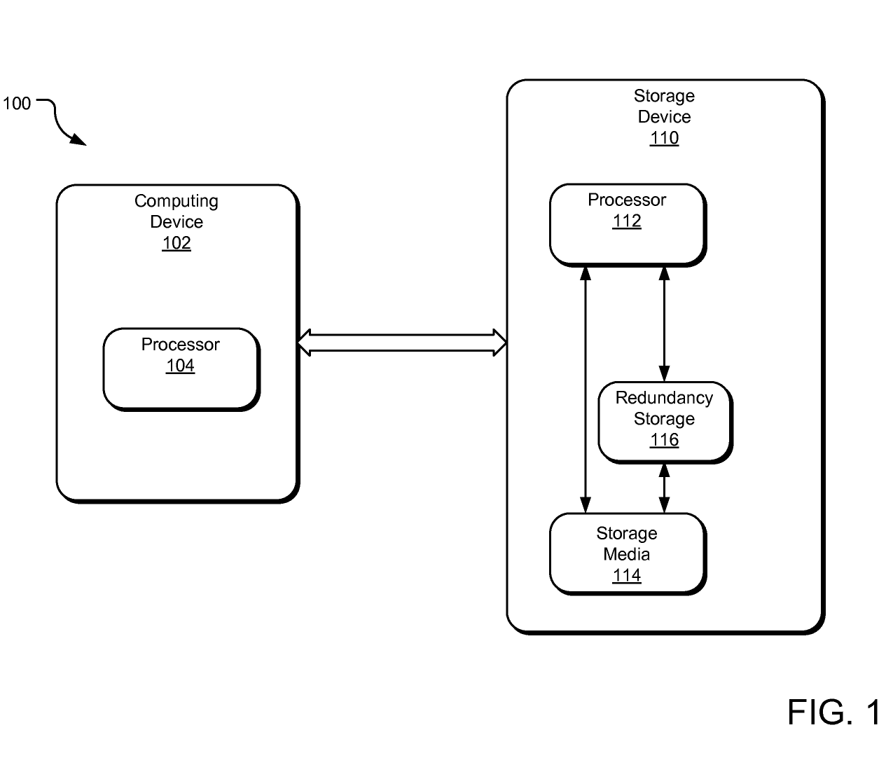

FIG. 1 is a block diagram illustrating an implementation of a system 100 for separately stored redundancy. The system 100 includes a computing device 102 that is communicatively connected to a storage device 110. The computing device 102 may be, for example, a computer, a server, a smart-phone, etc. The storage device 110 may be, for example, a hard-disc drive, a solid-state storage drive, etc. In one implementation, both the computing device 102 and the storage device 110 are contained on a same device, such as a computer.

The computing device 102 is illustrated to have a processor 104 that manages the computing device 102 and its communication with the storage device 110. The storage device 110 includes a storage media 114. Examples of the storage media 114 include magnetic storage media, optical storage media, solid-state storage media, etc. The storage device 110 includes a redundancy storage 116 that is distal from the storage media 114. For example, in one implementation, the redundancy storage 116 is provided in the form of a plurality of registers located on the storage device 110. The storage processor 112 calculates redundancy for data on the storage media 114 and stores such redundancy in the redundancy storage 116. In one implementation, the redundancy storage 116 is part of a storage area that is designated for storing other metadata about the data stored in the storage media 114. Yet alternately, other dynamic information about the data stored on the storage media, such as mapping information of the data, including dynamically determined mapping information, is also stored together with the redundancy information about the data.

In one implementation, the processor 104 initiates a write operation for writing a data block on the storage device 110. An example write operation provides a block of data to the storage device 110 without specifying the location where the block of data should be written on the storage media 114. In such case, the processor 112 determines the location of the data to be written. The processor 112 receives the write operation with the block of data and it calculates a redundancy based on the data. The processor 112 may calculate redundancy using a parity bit, a cyclical redundancy check (CRC), etc. In one implementation, the processor 112 calculates the redundancy using not only the data, but also the address where the data is stored on the storage media 114. Subsequently, the processor 114 stores the data in the storage media 114 and the redundancy in the redundancy storage 116.

In yet alternate implementation, storing the redundancy is managed with the same processes that are used to store forward map entries that address the assigned media location for the data block on the storage media 114. Thus, for example, the processor stores the redundancy together with the pointer to the physical location of the data on the storage media 116. Yet alternately, a redundancy pointer is stored in the forward map wherein the redundancy pointer points to the location of the redundancy in the redundancy storage 116. In such an implementation, a relation is established between the pointer to the data block and the redundancy pointer.

An implementation of the system also uses critical data authenticity values for generating the redundancy, and uses them to seed the redundancy generation. Examples of such critical data include the host address, media address, cycle number of writes to the host address, cycle number of writes to the media address, etc. The critical values that are unique by location are also stored in the forward map. In one implementation, the cycle number for the media is the same value for an erasure block or group of erasure blocks that make up a garbage collection unit. Similarly, the cycle number for the media is the same value for an SMR band or group of tracks that make up a garbage collection unit. Such critical values that are not unique by location do not have to be replicated for each forward map entry, but can instead by stored with the entry for the respective garbage collection unit.

When it is required to read the data from the storage media 114, the processor 104 initiates a read operation providing the data block to be read. In response to such read operation, the processor 112 determines the location where the data block is stored on the storage media 114. The processor 112 also determines the location of the redundancy for the data block to be read. Subsequently, the processor 112 verifies the accuracy of the data by recalculating the redundancy and comparing the recalculated value of the redundancy with the value of the redundancy retrieved from the redundancy storage 116. The processor 112 determines the location of the redundancy based on a redundancy pointer. Such a redundancy pointer may be stored with the forward map entries related to the data block.

As a result of such implementation, the system 100 provides fault isolation between the data storage and the redundancy storage. As a result, misdirected accesses that might otherwise result in coherent data and redundancy are reduced. For example, if redundancy related to a data block is co-located with the data block on the storage media 114, a misdirected read operation to such location with stale data and the related redundancy results in a misdirected read as the redundancy matches the stale data. With the system 100 disclosed in FIG. 1 that provides separately stored redundancy, the stale data from the storage media 114 will not match the redundancy stored on the redundancy storage 116, and therefore, the problem of misdirected read is avoided.

Another situation where the system 100 providing separately stored redundancy improves over a system providing for co-located redundancy, involved re-use of a region of the storage media 114, such as a band or a track, with a repeat of the host address. For example, suppose that a same host address gets allocated a multiple number of times in a row to a same media location, however, the actual write operation is mis-directed. In such a case, the data at the media location will retain its old state and data, together with its originally calculated, now stale, redundancy. In this case, a subsequent read operation to that media address will result in stale data that will match the stale redundancy. However, with the implementation of the system 100 disclosed in FIG. 1, such subsequent read operation is able to detect the stale data due to the newly calculated value of redundancy that is stored in the redundancy storage 116.

Similarly, if a write operation is mis-directed to a media location that is proximate to the host directed media location, such as a neighboring page or sector, if the redundancy is stored together with the data, such mis-directed write will not be detected by a subsequent read operation. Compared to that, with the implementation of the system 100 disclosed in FIG. 1, such subsequent read operation is able to detect the stale data due to the newly calculated value of redundancy that is stored in the redundancy storage 116.

In yet alternate implementation of the system 100, the processor 112 also includes one more additional pieces of information to the redundancy stored in the redundancy storage 116. For example such additional information, known as salting, includes one or more key or critical characteristics of the data that the redundancy relates to. Such characteristics include, for example, compression characteristics of the data, host address, media address, cycle number of writes to the host address, cycle number of reads to the host address, etc.

The implementations described in FIG. 1 generally do not require any additional metadata as the redundancy is moved from storage in the storage media 114 to the redundancy storage 116. Furthermore, the amount of storage and retrieval work also does not increase substantially as the access to and use of the redundancy is managed together with management of forward map entries.

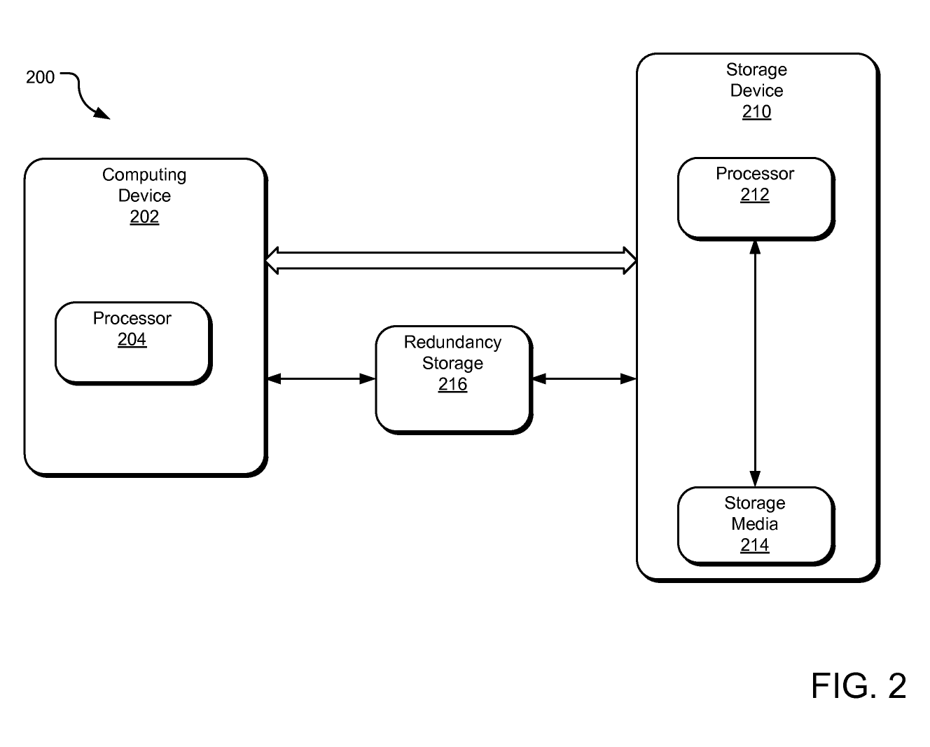

FIG. 2 is a block diagram illustrating an alternate implementation of a system 200 for separately stored redundancy. The system 200 provides a computing device 202 communicatively connected to a storage device 210. A processor 204 of the computing device 202 communicates with the storage device 210 to initiate one or more operations, such as a write operation, a read operation, etc. Upon receiving a write operation from the processor 204, the processor 212 generates a redundancy based on the write data. Subsequently, the processor 212 writes the data to the storage media 214 and the redundancy to the redundancy storage 216.

As illustrated in system 200, the redundancy storage 216 is located separate from the storage device 216. In other words, the redundancy storage 216 is isolated from the storage device 216. For example, in one implementation, the storage device 210 is located inside the computing device 202, and the redundancy storage 216 is located on the motherboard of the computing device 202. In an implementation of the system 200, it is the processor 204 that calculates and stores the redundancy in the redundancy storage 216. In such an implementation, the processor 204 may also compare any data read pursuant to a read operation against its redundancy stored in the redundancy storage 216.

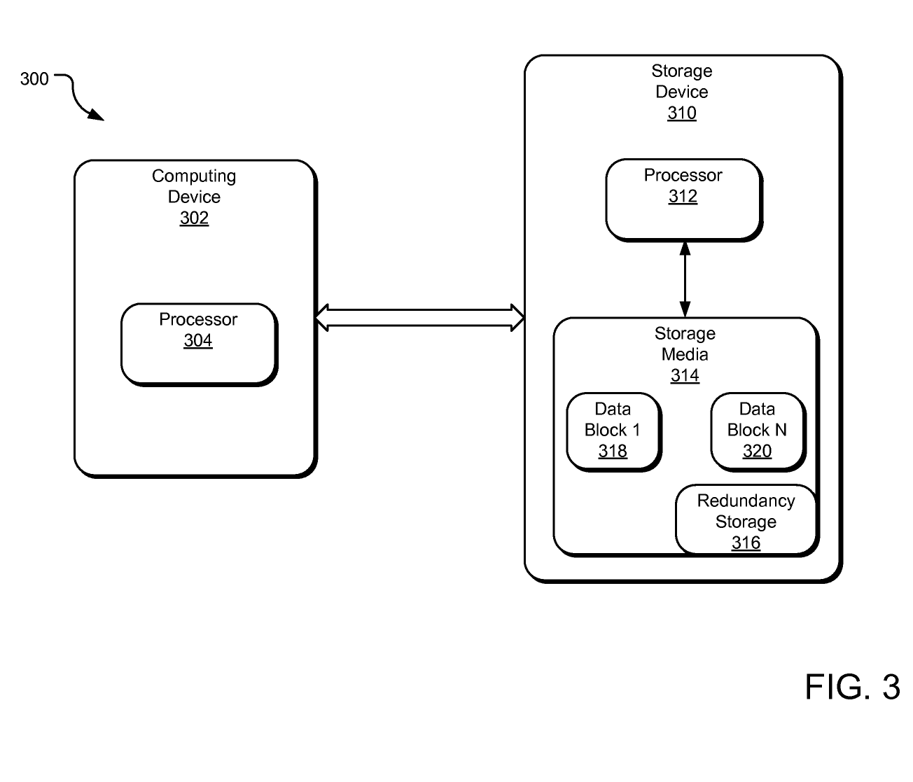

FIG. 3 is a block diagram illustrating an alternate implementation of a system 300 for separately stored redundancy. The system 300 provides a computing device 302 communicatively connected to a storage device 310. A processor 304 of the computing device 302 communicates with the storage device 310 to initiate one or more operations, such as a write operation, a read operation, etc. Upon receiving a write operation from the processor 304, the processor 312 generates a redundancy based on the write data. Subsequently, the processor 312 writes the data to the storage media 314 and the redundancy to the redundancy storage 316.

As illustrated in system 300, the redundancy storage 316 is located on the storage media 316. For example, in one implementation, a specific storage area near the end of the storage media 314 is allocated for redundancy storage 316. Thus, even though the redundancy storage 316 is located on the storage media 314, it is separate and away from each of the storage regions where the data blocks are stored, such as the data block 1 318, data block 2 320, etc. In such an implementation, upon receiving instructions for a read operation, the processor 312 reads the data blocks and verifies the accuracy of the read data using the redundancy stored in the redundancy storage 316. In an alternate implementation, values representing other characteristics of the stored data, such as compression characteristics of the data, host address, media address, cycle number of writes to the host address, cycle number of reads to the host address, etc., are also stored in the redundancy storage 316.

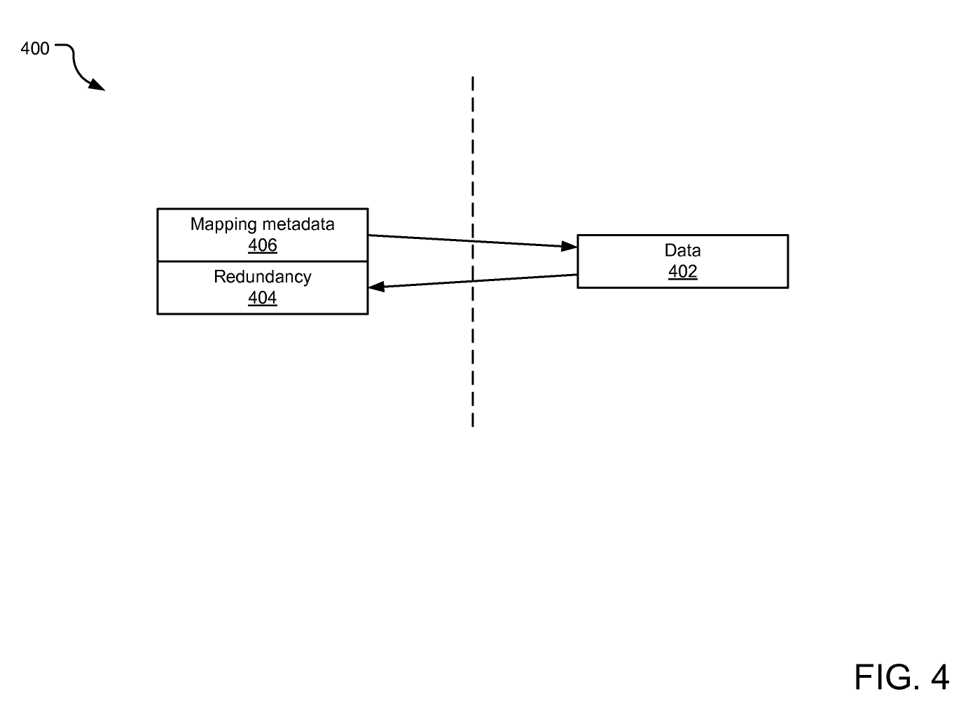

FIG. 4 illustrates an example data structure 400 of a redundancy stored separately and away from data. Specifically, the data structure 400 illustrates a block of data 402 stored on a storage media. For example, the data 402 is stored on a magnetic disc, an optical disc, a solid-state storage media, etc. A redundancy 404 is calculated based on the data 402. In one implementation, the redundancy 404 is calculated based on the data 402. For example, a storage device processor calculates redundancy 404 based on the block of data received in a write operation, wherein the location where the data is to be stored is given by mapping metadata 406. In one implementation, the mapping metadata 406 includes a forward map entry that points to the media location for the data 402. In such an implementation, the storing and retrieving the redundancy 404 is managed with the same process as used for the storing and retrieving of the forward map entries, of the mapping metadata 406, that points to the media location for the data storage.

In such an implementation, when a read operation is executed for reading the data 402, the data 402 is verified based on the value of the redundancy 404. Because the data 402 and redundancy 404 are stored separately and apart from each other, the data structure 400 provides a higher level of data authentication and data reliability.

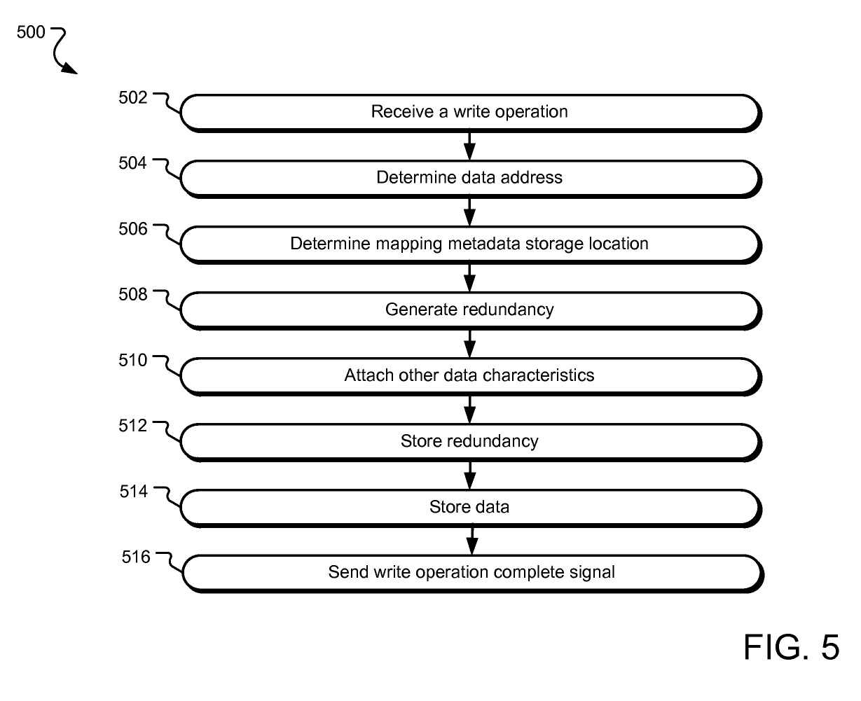

FIG. 5 illustrates example operations 500 for providing separately stored redundancy in a data storage system. A receiving operation 502 receives instructions for a write operation. Such instructions are communicated from a host device to the storage device. Example instructions for a write operation include the data that is to be written to the storage media. Alternately, the write operation also specifies the media address where the data is to be stored. Subsequently, a determining operation 504 determines a data address where the data block is to be stored. For example, such data address may be part of the instructions for a write operation received from a host device. Alternately, in a storage device using dynamic mapping of data, the storage device itself determines the data address on the media where the data is stored.

Subsequently, a determining operation 506 determines the storage location where the mapping metadata is stored. For example, determining operation 506 determines one or more registers on a storage device, a section of the storage media, etc., as the storage location for the mapping metadata. In an alternative implementation, the determining operation 506 determines the storage location where the mapping metadata is stored to be at a location outside of the storage device.

A generating operation 508 generates redundancy for the data. Such generation of redundancy may be done using a cyclical redundancy check (CRC) calculation algorithm, a parity check calculation algorithm, etc. Subsequently, an attaching operation 510 attaches one or more other data characteristics to the redundancy. Such characteristics include, for example, compression characteristics of the data, host address, media address, cycle number of writes to the host address, cycle number of reads to the host address, etc. In one implementation, the attaching operation 510 also attaches the mapping metadata to the redundancy. For example, such mapping metadata may include forward map entries that point to the location of the data on the media.

A storing operation 512 stores the redundancy. In one implementation, the storing operation 512 stores the redundancy together with the mapping metadata. Alternatively, the redundancy is stored with the mapping metadata at a location determined by determining operation 506. In an alternative implementation, the storing operation 512 stores the redundancy at a storage location on the storage device on which the data is to be stored. However, in an alternate implementation, the storing operation 512 stores the redundancy at a storage location that is located outside the storage device on which the data is to be stored. In an implementation where the storage device uses dynamic mapping of data stored in the storage media, the forward map entries about the address of the data in the storage media is also stored together with the redundancy at the redundancy storage location. Subsequently, a storing operation 514 stores data in the storage media of the storage device. In an alternative implementation, the order of the operations 512 and 514 is reversed in that the data is stored first and then the redundancy is stored. Subsequently, an operation 516 sends a Complete Write Operation signal back to the system of device sending the write operation.

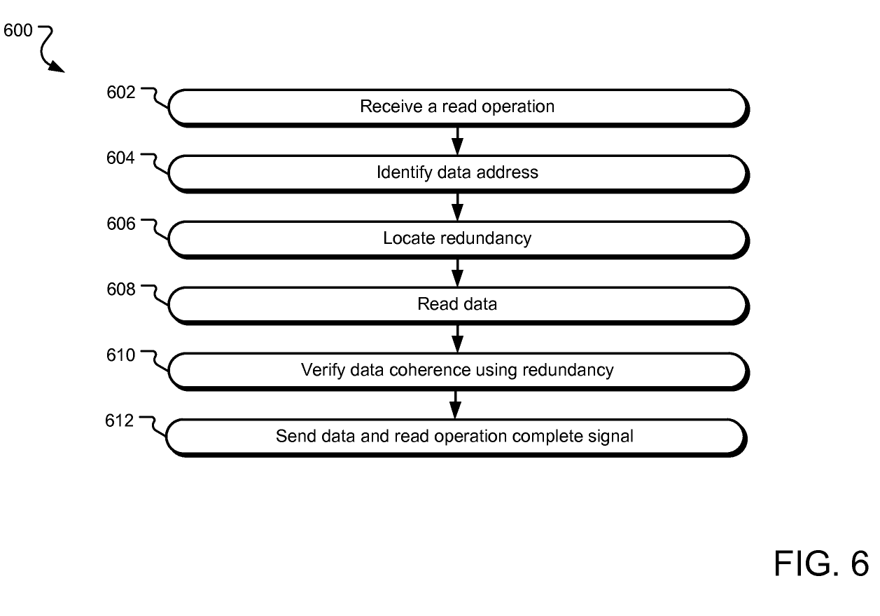

FIG. 6 illustrates example operations 600 for providing separately stored redundancy in a data storage system. Specifically, operations 600 disclose reading data from storage media wherein the redundancy about the data is stored separately and away from the location where data is stored. A receiving operation 602 receives instruction for a read operation for reading data from a storage media. For example, the receiving operation 602 receives such instruction for a read operation from a host device. In response to the instructions for read operation, an identifying operation 604 identifies an address of the data that is required to be read from the storage media. For example, the identifying operation identifies the physical address of the storage region, such as tracks, bands, etc., where the data is stored on the storage media.

Subsequently, a locating operation 606 locates the redundancy for the data to be read. In one implementation, the locating operation 606 locates the redundancy based on the location of the mapping metadata. Alternatively, the locating operation 606 may identify such redundancy based on a dynamic mapping table. For example, a mapping table relates storage media data addresses to the redundancies related thereto. Alternately, a mapping table relates storage media data addresses to addresses where their redundancies are stored.

A reading operation 608 reads the data from the storage media. Subsequently, a verifying operation 610 verifies data coherence for the read data using the redundancy. In one implementation, such verifying includes computing a new value of the redundancy based on the data read by the reading operation 608 and comparing the newly computed redundancy with the redundancy located by the locating operation 606. An operation 612 sends data to the system or device requesting the data and a Read Operation Complete signal.

Because the redundancy is stored together with the mapping metadata for the data storage block, the task for retrieving of the redundancy does not add substantially additional operations compared to the tasks related to retrieving redundancy located together with the data itself. On the other hand, because the redundancy is located separately from the data, this method of storing the data redundancy separate from the data and together with the mapping metadata provides fault isolation between the data storage and the redundancy storage. As a result, misdirected accesses that may otherwise result in incorrect coherency between the data and the data redundancy are avoided.

The implementations described herein may be implemented as logical steps in one or more computer systems. The logical operations of the various implementations described herein are implemented (1) as a sequence of processor-implemented steps executing in one or more computer systems and (2) as interconnected machine or circuit modules within one or more computer systems. The implementation is a matter of choice, dependent on the performance requirements of the computer system. Accordingly, the logical operations making up the implementations of the implementations described herein are referred to variously as operations, steps, objects, or modules. Furthermore, it should be understood that logical operations may be performed in any order, unless explicitly claimed otherwise or a specific order is inherently necessitated by the claim language.

In the interest of clarity, not all of the routine functions of the implementations described herein are shown and described. It will be appreciated that in the development of any such actual implementation, numerous implementation-specific decisions are made in order to achieve the developer's specific goals, such as compliance with application—and business-related constraints, and that those specific goals will vary from one implementation to another and from one developer to another.

The above specification, examples, and data provide a complete description of the structure and use of example implementations. Because many alternate implementations can be made without departing from the spirit and scope of the invention, the invention resides in the claims hereinafter appended. Furthermore, structural features of the different implementations may be combined in yet another implementation without departing from the recited claims.

What is claimed is:

1. A method comprising:
storing a data block redundancy related to a data block of a storage medium together with the mapping metadata for the data block at a redundancy storage location that is not adjacent to the storage location of the data block on the storage medium.

2. The method of claim 1, wherein the mapping metadata further comprises a forward map entry pointing to the location of the data block on the storage medium.

3. The method of claim 2, wherein the forward map entry includes at least one of a media address identifying the storage location of the data block, cycle number of writes to the host address, and cycle number of writes to the media address.

4. The method of claim 2, further comprising:
receiving instructions for a read operation, the read operation specifying the logical block address (LBA) of the data to be read;
determining the location of the mapping metadata based on the LBA; and
retrieving the mapping metadata and the data block redundancy from the location of the mapping metadata.

5. The method of claim 4, further comprising:
retrieving data from the location of the data block on the storage medium; and
verifying the data coherency using the data block redundancy.

6. The method of claim 1, wherein the redundancy storage location is on a separate block of the storage medium, the separate block being in a storage region other than the storage region of the data block.

7. The method of claim 1, wherein the redundancy storage location is on another storage medium separate from the storage medium of the data block.

8. The method of claim 1, wherein the storage device is a disc drive using shingled media recording (SMR).

9. The method of claim 1, wherein the storage device is a solid-state device (SSD).

10. The method of claim 1, wherein the storage device is a disc drive and redundancy storage location is on a track of the disc drive other than the track storing the data block.

11. The method of claim 1, wherein the data block redundancy is calculated using at least one of (1) a host address identifying the storage location of the data block; (2) a media address identifying the storage location of the data block; (3) cycle number of writes to the host address; and (4) cycle number of writes to the media address.

12. A storage device comprising:
a storage medium; and
a processor adapted to store a data block redundancy related to a data block of a storage medium together with the mapping metadata for the data block at a redundancy storage location that is not adjacent to the storage location of the data block on the storage medium.

13. The storage device of claim 12, wherein the processor is further configured to store the data block redundancy and the mapping metadata on another storage medium separate from the storage medium of the data block.

14. The storage device of claim 14, wherein the another storage medium is located outside of the storage device.

15. The storage device of claim 12, wherein the storage device is at least one of a disc drive using shingled media recording (SMR) and a solid-state device (SSD).

16. The storage device of claim 12, wherein the data block redundancy is calculated using critical data authenticity values related to the data block.

17. The storage device of claim 12, wherein the mapping metadata further comprises a forward map entry pointing to the location of the data block on the storage medium.

18. A storage system comprising:
a storage device having a first storage medium and a second storage medium, the second storage medium not being adjacent to the first storage medium;
a processor adapted to generate a data block redundancy for a data block on the first storage medium and store, on the second storage medium, the data block redundancy related to the data block on the first storage medium together with the mapping metadata for the data block.

19. The storage device of claim 18, wherein the second storage medium is a set of registers associated with a processor of the storage device.

20. The storage device of claim 18, wherein the mapping metadata further comprises a forward map entry pointing to the location of the data block on the first storage medium.
